(19) United States
(12) Patent Application Publication
(10) Pub. No.: US 2017/0074563 A1
(43) Pub. Date: Mar. 16, 2017

(54) REFRIGERANT PIPING DEVICE

(71) Applicants: De-Fong HSIEH, Kaohsiung City (TW); De-Yin Hsieh, Kaohsiung City (TW)

(72) Inventors: De-Fong HSIEH, Kaohsiung City (TW); De-Yin Hsieh, Kaohsiung City (TW)

(21) Appl. No.: 15/190,501

(22) Filed: Jun. 23, 2016

(30) Foreign Application Priority Data
Sep. 10, 2015 (TW) 104129874

(51) Int. Cl. F25B 47/00; F24H 1/10; F25B 41/06; H05B 3/46; F25B 39/00; F28D 1/047

(52) U.S. Cl. CPC F25B 47/006; F25B 39/00; F28D 1/0477; F25B 41/067; H05B 3/46; F24H 1/102; F25B 2400/01; F25B 39/02

(57) ABSTRACT

A refrigerant piping device includes a refrigerating head, an input unit connected to the refrigerating head to input refrigerant, and an output unit connected to the refrigerating head to output refrigerant. The output unit includes a refrigerant return pipe connected to the refrigerating head, and a heating module configured on the refrigerant return pipe to heat up the refrigerant inside the refrigerant return pipe. The refrigerant return pipe is configured with a heating module to heat up the refrigerant inside the pipe, and the heating can remove the frozen state of the refrigerant return pipe to recover the original flexibility and function of the refrigerant return pipe, thus avoiding the problem wherein the refrigerant return pipe is frozen and gets brittle under the low temperature, and breakage due to the high-speed reciprocating motion of the refrigerating head left and right, back and forth, or up and down.

### CROSS-REFERENCE TO RELATED U.S. APPLICATIONS Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a refrigerant piping device, and more particularly to a refrigerant piping device which is used in synergy with the condenser and compressor.

2. Description of Related Art Including Information Disclosed Under 37 CFR 1.97 and 37 CFR 1.98.

Referring to FIG. 1, an ordinary refrigerant recycling system depends on a compressor 10 to compress low-temperature and low-pressure refrigerant and convert it to high-temperature and high-pressure gaseous refrigerant. Then, after cooling by the condenser 11, the gaseous refrigerant is condensed and converted to normal-temperature high-pressure liquid refrigerant. Next, after depressurization by the refrigerant controller 12, the liquid refrigerant will go into the evaporator 13 under a low temperature for evaporation and heat absorption, and be converted to low-temperature and low-pressure gaseous refrigerant, which is returned to the compressor 10 to start the cycle again. Based on the refrigeration caused by long-time continuous operation of the compressor 10, a continuous low-temperature cooling effect can be achieved.

The evaporator 13 used to cool semiconductor components (IC) for testing is usually called a refrigerating head or cooling head. Different from the structure of evaporators for ordinary air conditioners, it allows combination with a moving mechanism in reciprocating motion at a very high speed, to quickly contact and leave the tested semiconductor component. The refrigerating head and refrigerant controller 12 are connected to each other through a refrigerant induction pipe 14. When the refrigerant controller 12 is an expansion valve, the refrigerant induction pipe 14 is a metal hose, and when the refrigerant controller 12 is a solenoid valve, the refrigerant induction pipe 14 is a capillary tube. Preferably, the refrigerant controller 12 for the device shall be solenoid valve in combination with capillary tube, and the refrigerating head and compressor 10 are connected to each other through a refrigerant return pipe 15. The refrigerant return pipe 15 is a metal hose.

Because the refrigerant passing through the refrigerant return pipe 15 is of a very low temperature, the refrigerant return pipe 15 may be frozen and become brittle. Moreover, the high-speed reciprocating motion will cause a pulling force to continuously tighten the refrigerant return pipe 15, leading to fatigue of the metal and final breakage. And as a result, the refrigerant will leak out from the crack, and the user will have to terminate the operation and suffer from a loss.

Thus, to overcome said problems of the prior art, it would be an advancement in the art to provide an improved structure that can significantly improve the efficacy.

Therefore, the inventors have provided the present invention of practicability after deliberate design and evaluation based on years of experience in the production, development and design of related products.

### BRIEF SUMMARY OF THE INVENTION

The objective of the present invention is to provide a refrigerant piping device that can maintain a buffering effect to prevent breakage of the piping under a low-temperature freezing state and in a high-speed motion.

Accordingly, the refrigerant piping device of the present invention is a device under low-temperature freezing state and capable of high-speed reciprocating motion, comprising a refrigerating head, an input unit connected to the refrigerating head to input refrigerant, and an output unit connected to the refrigerating head to output refrigerant.

The output unit comprises a refrigerant return pipe connected to the refrigerating head, and a heating module configured on the refrigerant return pipe to heat up the refrigerant inside the refrigerant return pipe.

Efficacy of the present invention: as the refrigerant return pipe is configured with a heating module to heat up the refrigerant inside the pipe, the heating effect can remove the freezing state of the refrigerant return pipe, and recover the original flexibility and function of the return pipe, and thus can avoid the problem that the refrigerant return pipe is frozen under the low temperature and gets brittle, and can also avoid breakage caused by the high-speed reciprocating motion of the refrigerating head left and right, back and forth, or up and down.

### BRIEF DESCRIPTION OF THE SEVERAL VIEWS OF THE DRAWINGS

Other features and advantages of the present invention will be readily apparent from the description of embodiments when taken in conjunction with the accompanying drawings, wherein:

FIG. 1 is a schematic view to illustrate an existing refrigerant recycling system.

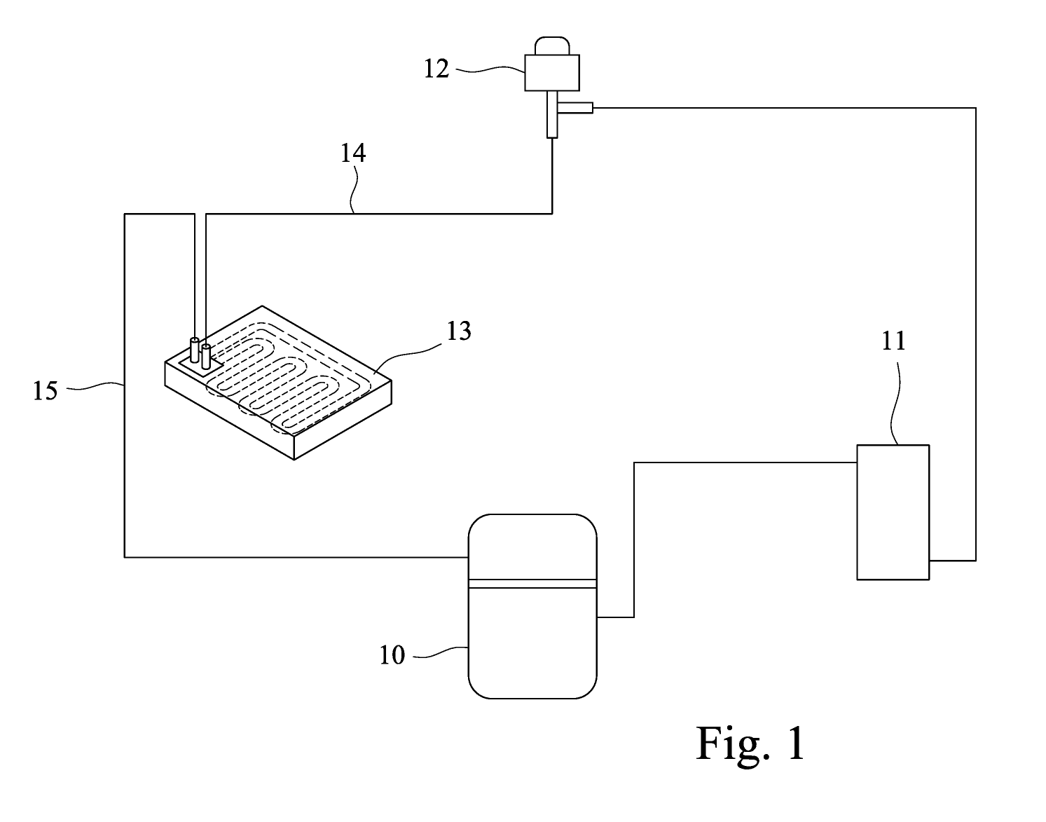

FIG. 2 is an exploded perspective view to illustrate a first embodiment in accordance with the present invention of a refrigerant piping device.

FIG. 3 is an exploded perspective view to illustrate a second embodiment in accordance with the present invention of a refrigerant piping device.

FIG. 4 is an exploded perspective view to illustrate a third embodiment in accordance with the present invention of a refrigerant piping device.

FIG. 5 is an exploded perspective view to illustrate a fourth embodiment in accordance with the present invention of a refrigerant piping device.

FIG. 6 is an exploded perspective view to illustrate a fifth embodiment in accordance with the present invention of a refrigerant piping device.

FIG. 7 is an exploded perspective view to illustrate a sixth embodiment in accordance with the present invention of a refrigerant piping device.

FIG. 8 is a schematic view of the situation that the refrigerant induction pipe is wound on the refrigerant return pipe in the sixth embodiment.

### DETAILED DESCRIPTION OF THE INVENTION

Before reading detailed description of the present invention, it is to be noted that, in the following description, like components are designated by like reference numerals.

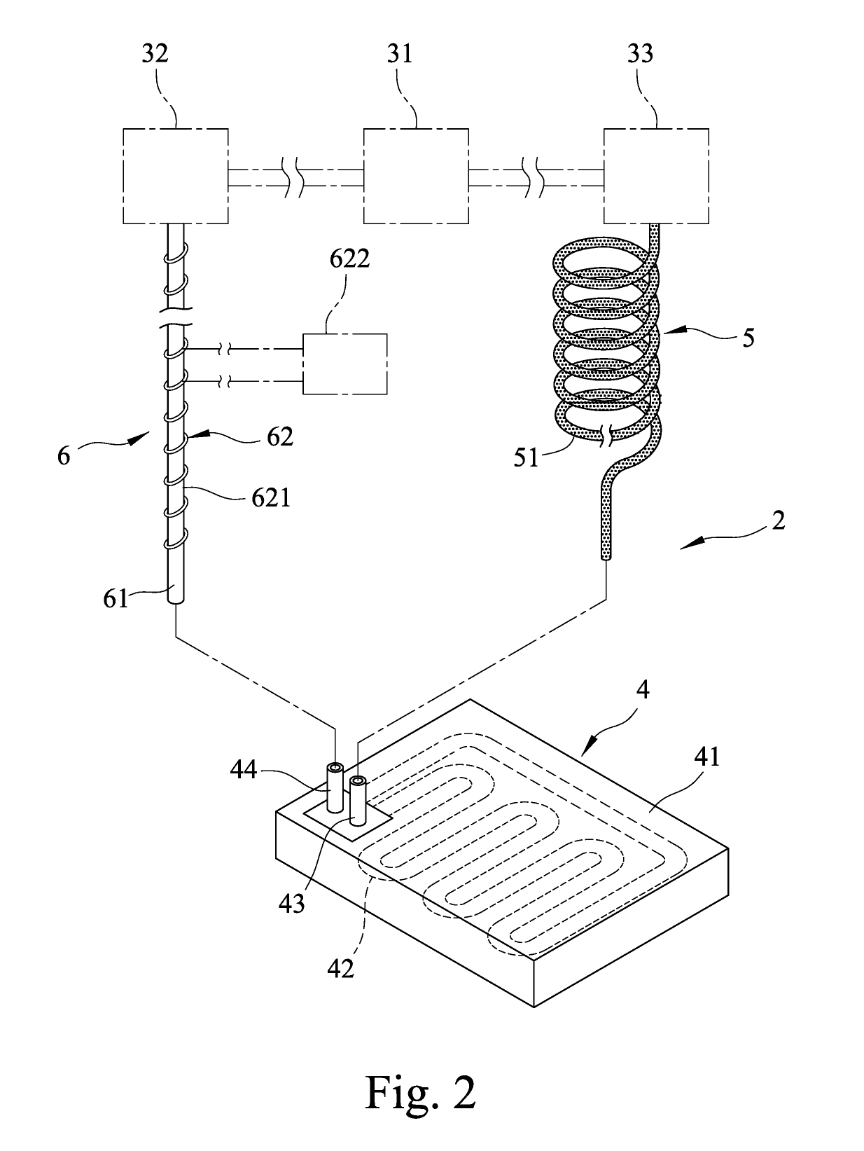

FIG. 2 discloses a first embodiment in accordance with the present invention of a refrigerant piping device 2. The refrigerant piping device 2 is used in synergy with a condenser 31, a compressor 32, and a refrigerant controller 33. The condenser 31, the compressor 32, and the refrigerant controller 33 are connected to each other as shown in FIG. 2. In the first embodiment, the refrigerant controller 33 is preferably a solenoid valve in combination with a capillary tube. These existing structures are shown in broken lines throughout the figures. The refrigerant piping device 2 includes a refrigerating head 4, an input unit 5 connected to the refrigerant controller 33 and the refrigerating head 4 to input refrigerant, and an output unit 6 connected to the refrigerating head 4 and compressor 32 to output refrigerant.

The refrigerating head 4 comprises a main body 41, a heat exchange structure 42 configured inside the main body 41, an input connector 43 configured on the main body 41 and connected to the heat exchange structure 42, and an output connector 44 configured on the main body 41 and connected to the heat exchange structure 42. The input connector 43 and the output connector 44 can be integrally formed with the main body 41 a, or separately mounted on the main body 41. The heat exchange structure 42 is a heat exchange refrigerant flow path, with its two ends respectively connected to the input connector 43 and the output connector 44.

The input unit 5 includes a refrigerant induction pipe 51, with its two ends respectively connected to the condenser 31 and the input connector 43 of the refrigerating head 4. The refrigerant induction pipe 51 is a capillary tube, and extends spirally in the form of a spring, as shown in FIG. 2. In this way, when the refrigerant induction pipe 51 is pulled, it will not be directly pulled to a tightened state. Therefore, it provides a function to buffer the pulling force.

The output unit 6 includes a refrigerant return pipe 61, with its two ends respectively connected to the output connector 44 of the refrigerating head 4 and the compressor 32, and a heating module 62 configured on the refrigerant return pipe 61 to heat up the refrigerant inside the refrigerant return pipe 61. The heating module 62 has an electric heating wire 621 wound on the refrigerant return pipe 61, and a heating source 622 electrically connected to the electric heating wire 621. In the first embodiment, the heating source 622 is preferably made up of a solid-state relay (SSR) and a temperature controller, to control the heat output of the electric heating wire 621 at an appropriate temperature.

The refrigerant is firstly cooled by the condenser 31, and then delivered to the refrigerant controller 33 for depressurization and converted to the low-temperature state. Then, it is inducted by the refrigerant induction pipe 51 of the input unit 5 to the refrigerating head 4. After passing the input connector 43 of the refrigerating head 4, it enters the heat exchange structure 42 for heat exchange to turn the refrigerating head 4 into a low-temperature state. Next, the refrigerant flows out from the output connector 44, passing the refrigerant return pipe 61 and returns to the compressor 32. At last, the compressor 32 compresses the refrigerant and delivers it to the condenser 31 to start the same cycle.

During the semiconductor testing operation, the refrigerating head 4 will have high-speed vertical, horizontal or back-and-front motion, to contact and cool the semiconductor (IC). Under excessive low temperature, the refrigerant induction pipe 51 and the refrigerant return pipe 61 will naturally be hardened and get brittle. In comparison, the present invention winds the refrigerant induction pipe 51 in the form of a spring, so that the refrigerant induction pipe 51 can extend when it is pulled. Thus, it will not be directly tightened and can buffer the pulling force to avoid breakage caused by the high-speed reciprocating motion of the refrigerating head 4. Moreover, the refrigerant return pipe 61 is configured with an electric heating wire 621 to heat up the refrigerant return pipe 61 so that it will not be frozen and get brittle under the low temperature. This can also provide an effect to avoid breakage of the pipe during the pull. In addition, the electric heating wire 621 can vaporize the refrigerant flowing inside, avoiding direct backflow of the refrigerant to the compressor 32 to cause a liquid compression phenomenon. Thus it provides a function to protect the compressor 32.

During the semiconductor (IC) low-temperature testing process, the average motion speed of refrigerating head 4 is: 15 cm vertical motion in 0.3 s and 30 cm horizontal motion in 0.3 s. An ordinary refrigerant pipeline will have metal fatigue and breakage in 5 to 6 days. But the lifecycle of the present invention of a refrigerant piping device 2 can be up to 5 to 6 months. It is apparent that the present invention has an effect to enhance the operational lifecycle.

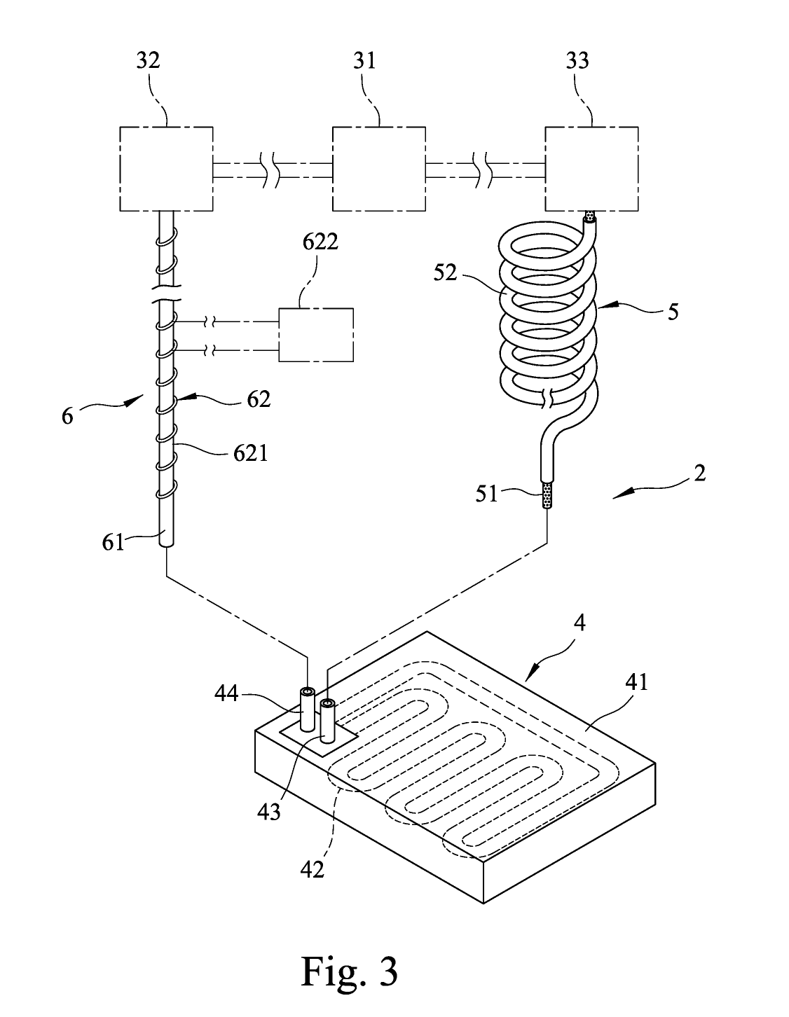

FIG. 3 discloses a second embodiment in accordance with the present invention of a refrigerant piping device 2. The second embodiment is roughly the same as the first embodiment. Its difference is: the input unit 5 also includes an outside enclosing pipe 52 sleeved on the refrigerant induction pipe 51. The outside enclosing pipe 52 is preferably a metal spring tube, but of course other materials can be applied as needed to protect the refrigerant induction pipe 51 and reinforce the structure.

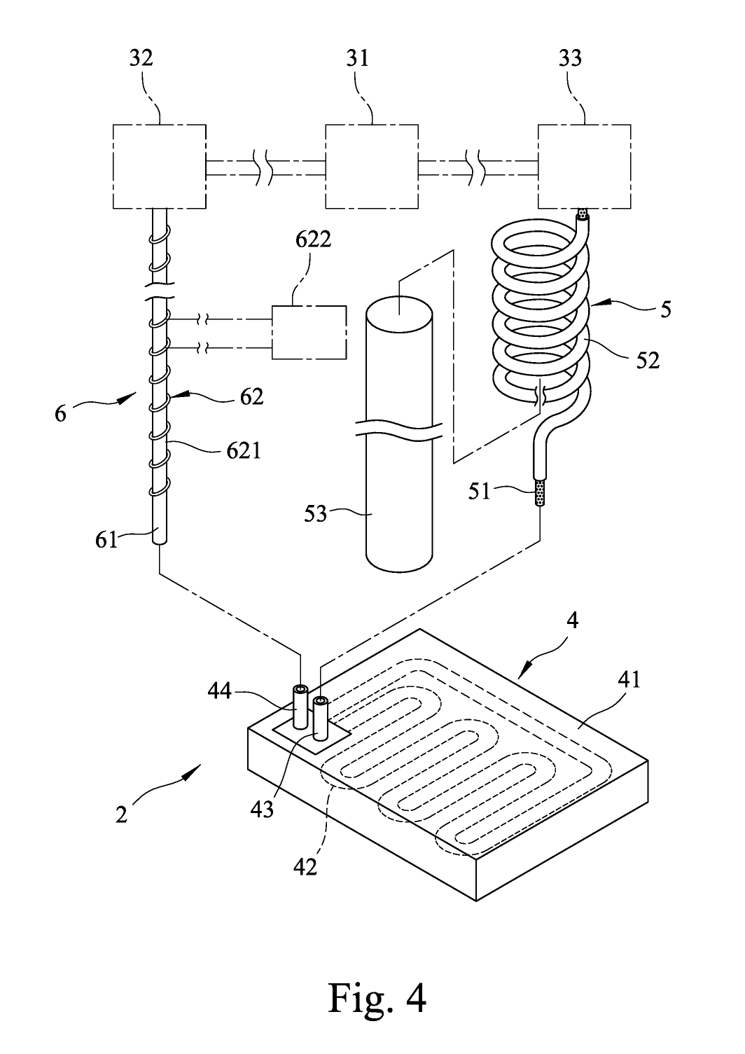

FIG. 4 discloses a third embodiment in accordance with the present invention of a refrigerant piping device 2. The third embodiment is roughly the same as the second embodiment. Its difference is: the input unit 5 also includes a positioning pipe 53 for the refrigerant induction pipe 51 to wind. The positioning pipe 53 is preferably a metal sprint tube, with its two ends respectively connected to the refrigerant controller 33 and the main body 41 of the refrigerating head 4. As the positioning pipe 53 can limit the refrigerant induction pipe 51, the refrigerant induction pipe 51 can be wound on the positioning pipe 53, so that the refrigerant induction pipe 51 is positioned and will not have violent swing left and right, or up and down.

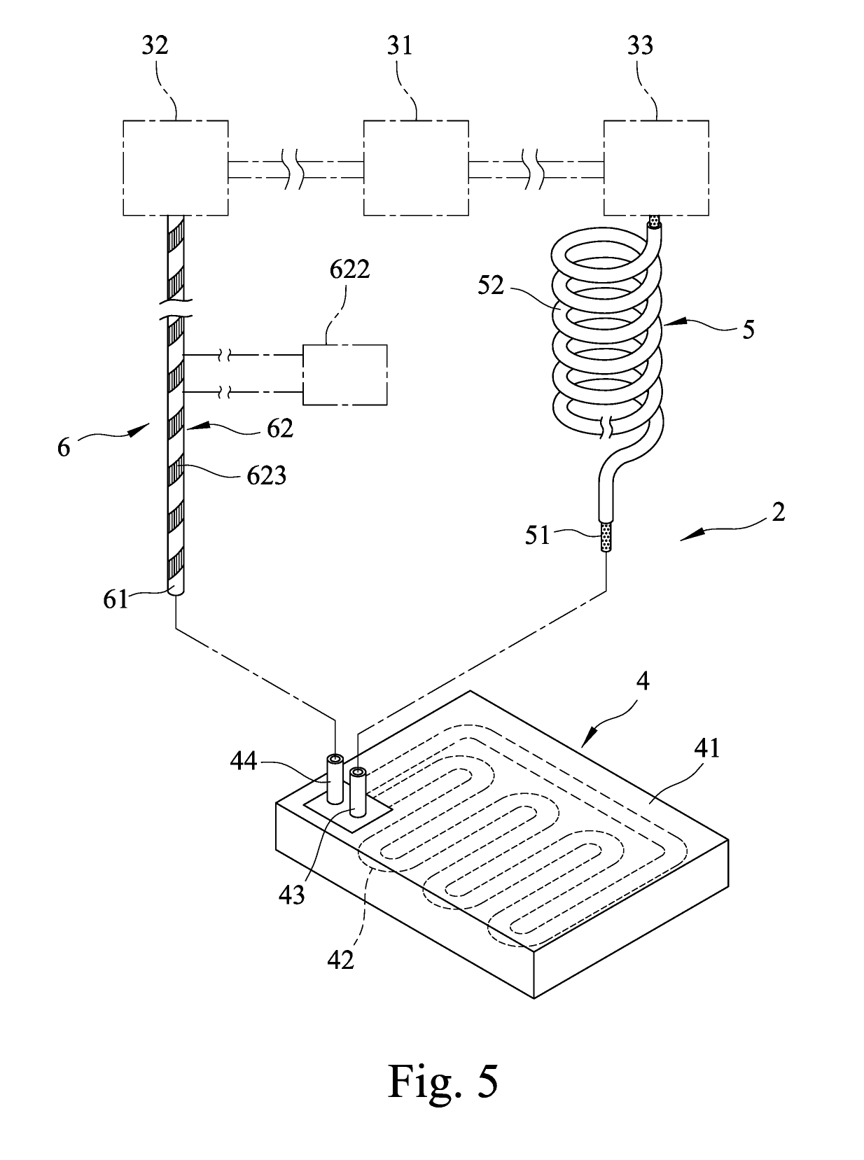

FIG. 5 discloses a fourth embodiment in accordance with the present invention of a refrigerant piping device 2. The fourth embodiment is roughly the same as the second embodiment. Its difference is: the heating module 62 has an electric heating strip 623 wound on the refrigerant return pipe 61, with its wire diameter larger than that of the electric heating wire 621(see FIG. 2) and shaped like a sheet. The fourth embodiment provides another type of configuration for the heating module 62, and can increases its applicability.

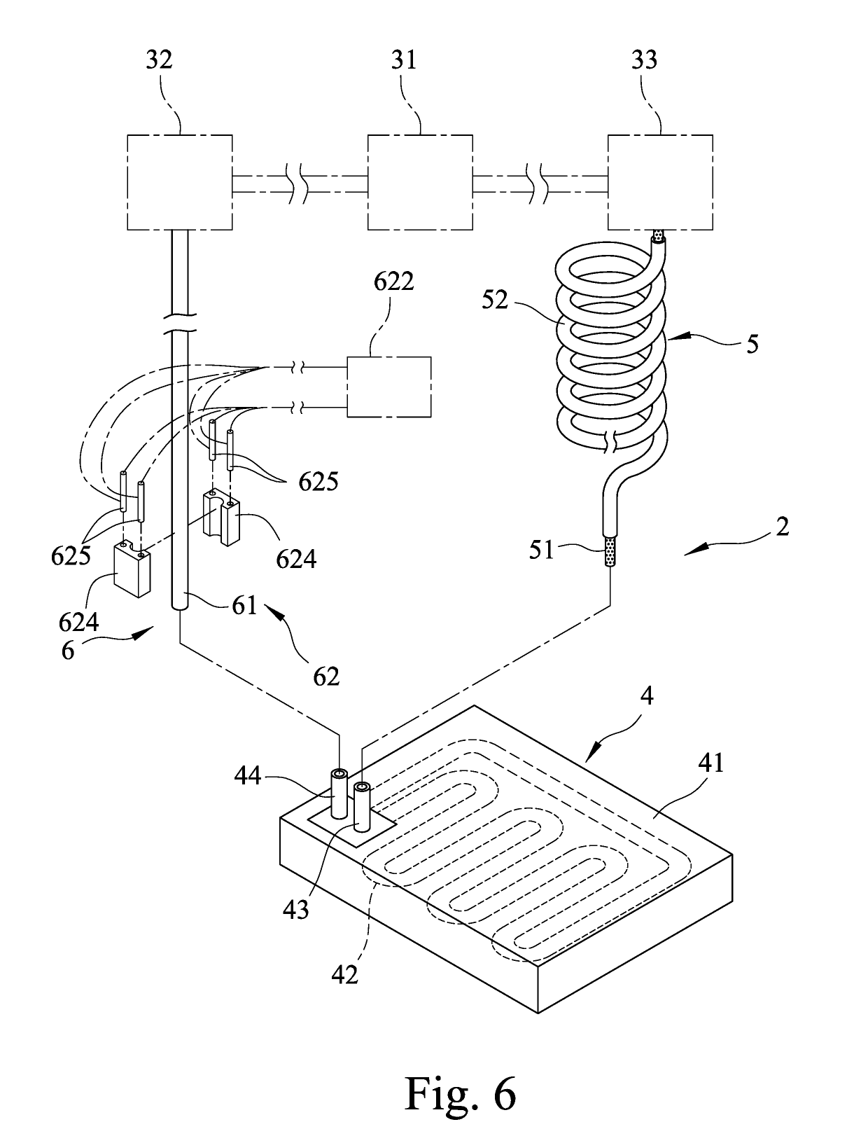

FIG. 6 discloses a fifth embodiment in accordance with the present invention of a refrigerant piping device 2. The fifth embodiment is roughly the same as the second embodiment. Its difference is: the heating module 62 has a plurality of electric heating blocks 624 working together to clamp the refrigerant return pipe 61. Each electric heating block 624 is inserted with two electric heating bars 625 electrically connected to the heating source 622. Such electric heating blocks 624 can transfer heat to the refrigerant return pipe 61, to avoid the problem that the refrigerant return pipe 61 is frozen and gets brittle under the low temperature. Such electric heating blocks 624 can be in the form of blocks, or any other shapes of existing heating components. The fifth embodiment provides another type of configuration for the heating module 62, and can increase its applicability.

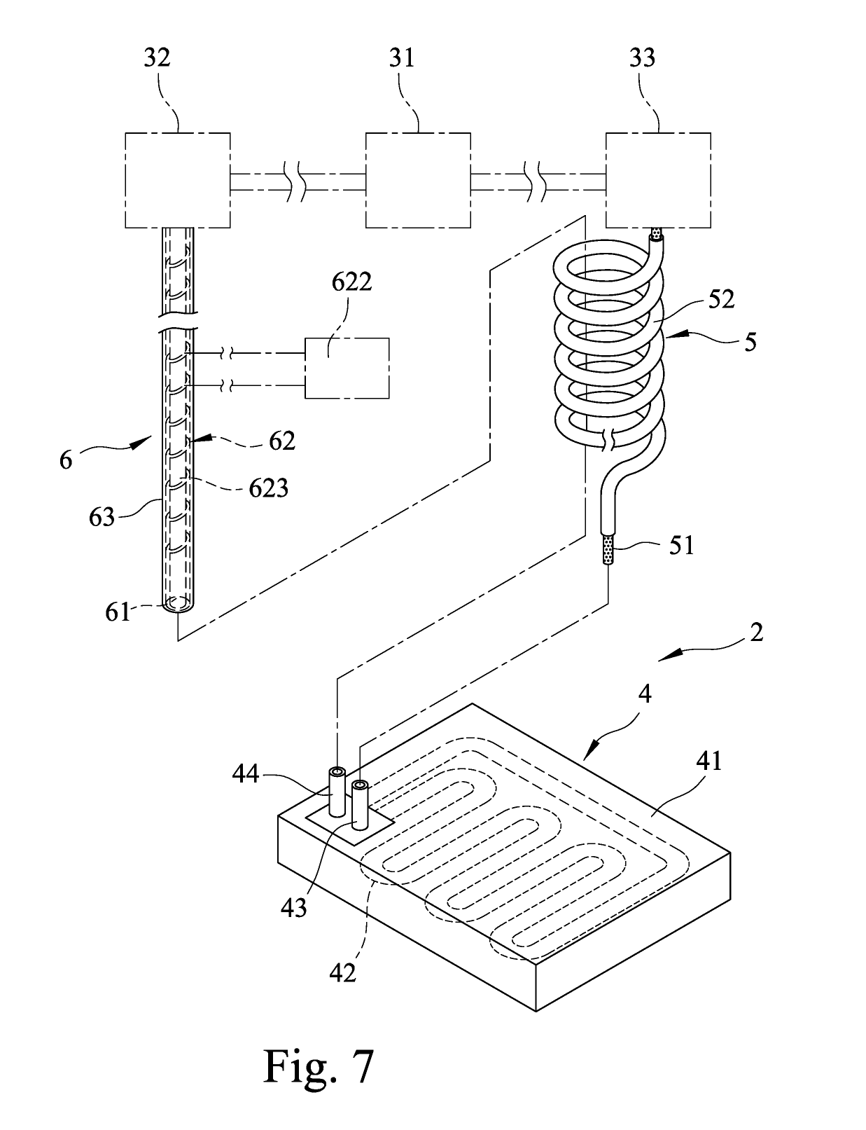

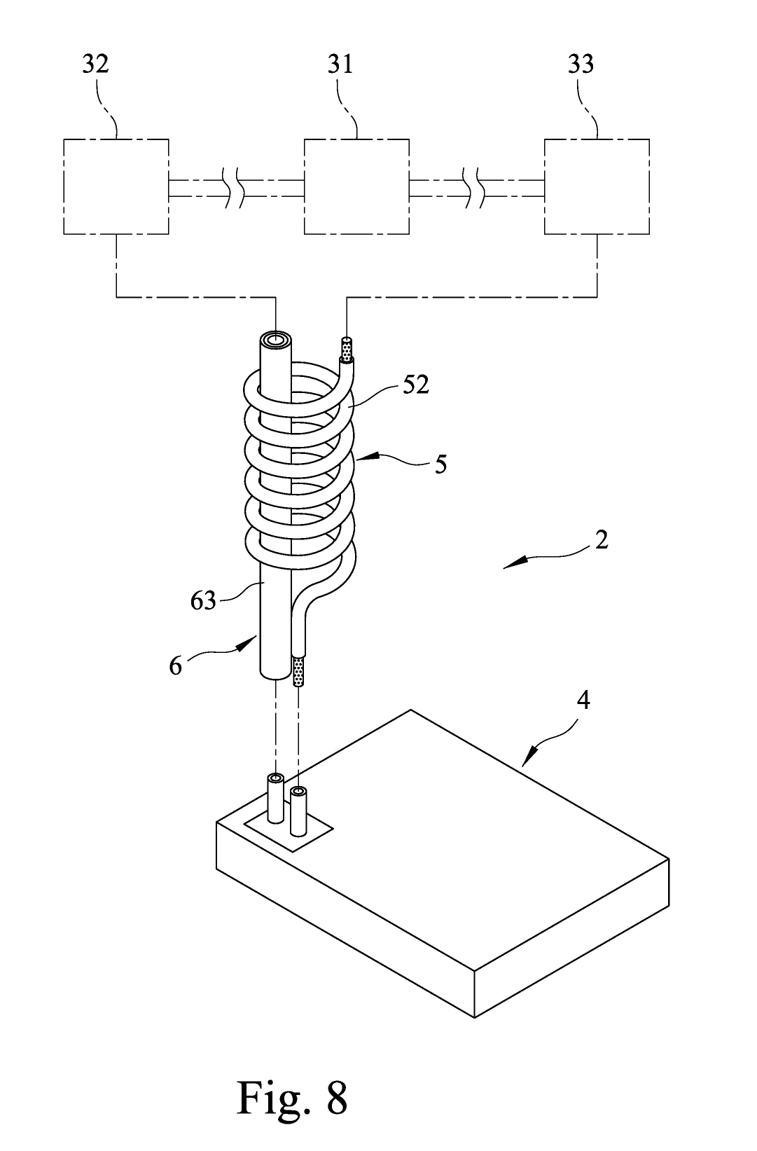

FIG. 7 and FIG. 8 disclose a sixth embodiment in accordance with the present invention of a refrigerant piping device 2. The sixth embodiment is roughly the same as the second embodiment. Its difference is: the output unit 6 also includes a thermal insulating layer 63 covering the refrigerant return pipe 61 and the electric heating wire 621 of the heating module 62, and the refrigerant induction pipe 51 is wound on the thermal insulating layer 63 and the refrigerant return pipe 61. Based on the above configuration, the refrigerant induction pipe 51 can be integrated and wound on the refrigerant return pipe 61, so that the refrigerant induction pipe 51 and the refrigerant return pipe 61 can be configured side by side, and the piping can be integrated to save space for configuration. To summarize, the refrigerant induction pipe 51 extends spirally in the form of a spring, so that it can have an effect to buffer the pulling force even if it is hardened under the low temperature. The refrigerant return pipe 61 is configured with a heating module 62 for heating to avoid the problem that the refrigerant return pipe 61 is frozen and gets brittle under the low temperature. Thus, it can extend the lifecycle of the refrigerant induction pipe 51 and the refrigerant return pipe 61. Therefore, the object of the present invention is achieved.

Although the invention has been explained in relation to its preferred embodiment, it is to be understood that many other possible modifications and variations can be made without departing from the spirit and scope of the invention as hereinafter claimed.

We claim:

1. A refrigerant piping device, capable of high-speed reciprocating motion and working under a low-temperature state, comprising:
a refrigerating head;
an input unit, connected to the refrigerating head to input refrigerant; and
an output unit, connected to the refrigerating head to output refrigerant, said output unit including a refrigerant return pipe connected to the refrigerating head, and a heating module configured on the refrigerant return pipe to heat up the refrigerant inside the refrigerant return pipe.

2. The device defined in claim 1, wherein said input unit includes a refrigerant induction pipe connected to the refrigerating head and extending spirally in the form of a spring, said refrigerant induction pipe being a capillary tube.

3. The device defined in claim 1, wherein said heating module of the output unit has a heating source, and an electric heating wire wound on the refrigerant return pipe and electrically connected to the heating source.

4. The device defined in claim 2, wherein said input unit also includes an outside enclosing pipe covering the refrigerant induction pipe.

5. The device defined in claim 2, wherein said input unit further includes a positioning pipe for the refrigerant induction pipe to wind on.

6. The device defined in claim 1, wherein said heating module of the output unit has a heating source, and an electric heating strip wound on the refrigerant return pipe and electrically connected to the heating source.

7. The device defined in claim 1, wherein said heating module of the output unit has a heating source, and a plurality of electric heating blocks working together to clamp the refrigerant return pipe, each electric heating block inserted with at least one electric heating bar electrically connected to the heating source.

8. The device defined in claim 2, wherein said refrigerating head comprises a main body, a heat exchange structure configured inside the main body to deliver refrigerant, an input connector configured on the main body and connected to the heat exchange structure to input the refrigerant to the heat exchange structure, and an output connector configured on the main body and connected to the heat exchange structure to output the refrigerant to the heat exchange structure, the refrigerant induction pipe of the input unit being connected to the input connector, and the refrigerant return pipe of the output unit being connected to the output connector.

9. The device defined in claim 2, wherein the output unit also includes thermal insulating layer that covers the refrigerant return pipe and the heating module, and the refrigerant induction pipe is wound on the thermal insulating layer and the refrigerant return pipe.
